(19) United States
(12) Patent Application Publication
(10) Pub. No.: US 2014/0005311 A1
(43) Pub. Date: Jan. 2, 2014

(54) POLYCARBONATE COMPOSITION WITH LOW STATIC PERFORMANCE

(71) Applicant: Bayer MaterialScience LLC, Pittsburgh, PA (US)

(72) Inventors: Robyn Francis, Moon Township, PA (US); James P. Mason, Carnegie, PA (US); Michael A. Gerace, Slovan, PA (US)

(21) Appl. No.: 13/933,371

(22) Filed: Jul. 2, 2013

Related U.S. Application Data
(60) Provisional application No. 61/667,115, filed on Jul. 2, 2012.

(51) Int. Cl. C08K 5/52

(52) U.S. Cl. CPC C08K 5/52
USPC 524/120

(57) ABSTRACT

The present invention provides a process for reducing static charge in a polycarbonate part involving combining a polycarbonate and a diphosphite to form a composition and molding a part from the composition, wherein the part exhibits reduced static charge compared to a part made without addition of the diphosphite.

### FIELD OF THE INVENTION

The present invention relates in general to plastics and more specifically to the inclusion of a phosphite compound in a polycarbonate composition to reduce static charge and resultant “water spotting” defects on plastic parts.

### BACKGROUND OF THE INVENTION

Plastic parts such as headlamp lenses molded from polycarbonate tend to develop a static charge during the injection molding process. This static charge can be problematic if the lenses are hard-coated as over spray from the coating process may become attracted to surface of the lenses and subsequently result in defects described by molders as “water-spots.” In addition, the lenses may be more prone to attract contaminants such as airborne dust particles, which cause visible defects after coating.

Therefore, a need exists in the art for a process of reducing static charge build up in polycarbonate parts.

### SUMMARY OF THE INVENTION

Accordingly, the present invention provides such a process for reducing static charge build up in polycarbonate parts.

It has been surprisingly found that the use of diphosphites such as bis(2,4-dicumylphenyl)pentaerythritol diphosphite significantly reduces the level of static charge in polycarbonate headlamp lenses and results in essentially defect free parts after hard-coating. Bis(2,4-dicumylphenyl)pentaerythritol diphosphite also exhibited superior performance in lab and production samples compared to the state of the art, tris(2,4-di-tert-butylphenyl)phosphite.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 shows dust pattern results measured with a Monroe probe;

FIGS. 2A, 2B and 2C illustrate dust pattern results measured with a Monroe probe; and

FIGS. 3A, 3B and 3C are photographs of headlight lenses made according to the invention.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

The present invention provides a process for reducing static charge in a polycarbonate part involving combining a polycarbonate and a diphosphite to form a composition and molding a part from the composition, wherein the part exhibits reduced static charge compared to a part made without addition of the diphosphite.

Suitable polycarbonate resins for useful in the present invention are homopolycarbonates and copolycarbonates, both linear or branched resins and mixtures thereof.

The polycarbonates have a weight average molecular weight of preferably 10,000 to 200,000, more preferably 20,000 to 80,000 and their melt flow rate, per ASTM D-1238 at 300° C., is preferably 1 to 65 g/10 min., more preferably 2 to 35 g/10 min. They may be prepared, for example, by the known diphasic interface process from a carbonic acid derivative such as phosgene and dihydroxy compounds by polycondensation (See, German Offenlegungsschriften 2,063,050; 2,063,052; 1,570,703; 2,211,956; 2,211,957 and 2,248,817; French Patent 1,561,518; and the monograph by H. Schnell, “Chemistry and Physics of Polycarbonates”, Interscience Publishers, New York, N.Y., 1964).

In the present context, dihydroxy compounds suitable for the preparation of the polycarbonates of the invention conform to the structural formulae (1) or (2) below.

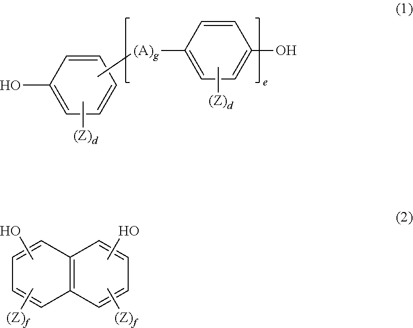

wherein
A denotes an alkylene group with 1 to 8 carbon atoms, an alkylidene group with 2 to 8 carbon atoms, a cycloalkylene group with 5 to 15 carbon atoms, a cycloalkylidene group with 5 to 15 carbon atoms, a carbonyl group, an oxygen atom, a sulfur atom, —SO— or —SO2 or a radical conforming to

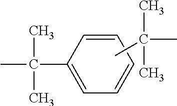

e and g both denote the number 0 to 1;
Z denotes F, Cl, Br or C1-C4-alkyl and if several Z radicals are substituents in one aryl radical, they may be identical or different from one another;
d denotes an integer of from 0 to 4; and
f denotes an integer of from 0 to 3.

Among the dihydroxy compounds useful in the practice of the invention are hydroquinone, resorcinol, bis-(hydroxyphenyl)-alkanes, bis-(4droxyl-phenyl)-ethers, bis-(hydroxyphenyl)-ketones, bis-(4ydroxyl-phenyl)-sulfoxides, bis-(hydroxyphenyl)-sulfides, bis-(hydroxyphenyl)-sulfones, and α,α-bis-(hydroxyphenyl)-diisopropylbenzenes, as well as their nuclear-alkylated compounds. These and further suitable aromatic dihydroxy compounds are described, for example, in U.S. Pat. Nos. 5,401,826, 5,105,004; 5,126,428; 5,109,076; 5,104,723; 5,086,157; 3,028,356; 2,999,835; 3,148,172; 2,991,273; 3,271,367; and 2,999,846, the contents of which are incorporated herein by reference.

Further examples of suitable bisphenols are 2,2-bis-(4-hydroxyphenyl)-propane (bisphenol A), 2,4-bis-(4-hydroxyphenyl)-2-methyl-butane, 1,1-bis-(4-hydroxyphenyl)-cyclohexane, α,α′-bis-(4-hydroxy-phenyl)-p-diisopropylbenzene, 2,2-bis-(3-methyl-4-hydroxyphenyl)-propane, 2,2-bis-(3-chloro-4-hydroxyphenyl)-propane, 4,4′-dihydroxy-diphenyl, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfide, bis-(3,5-dimethyl-4-hydroxy-phenyl)-sulfoxide, bis-(3,5-dimethyl-4-hydroxyphenyl)-sulfone, dihydroxy-benzophenone, 2,4-bis-(3,5-dimethyl-4-hydroxyphenyl)-cyclohexane, α,α′-bis-(3,5-dimethyl-4-hydroxyphenyl)-p-diisopropyl-benzene and 4,4′-sulfonyl diphenol.

Examples of particularly preferred aromatic bisphenols are 2,2-bis-(4-hydroxyphenyl)-propane, 2,2-bis-(3,5-dimethyl-4-hydroxyphenyl)-propane, 1,1-bis-(4-hydroxyphenyl)-cyclohexane and 1,1-bis-(4-hydroxy-phenyl)-3,3,5-trimethylcyclohexane. The most preferred bisphenol is 2,2-bis-(4-hydroxyphenyl)-propane (bisphenol A).

The polycarbonates useful in the invention may entail in their structure units derived from one or more of the suitable bisphenols.

Among the resins suitable in the practice of the invention are phenolphthalein-based polycarbonate, copolycarbonates and terpolycarbonates such as are described in U.S. Pat. Nos. 3,036,036 and 4,210,741, both of which are incorporated by reference herein.

The polycarbonates useful in the invention may also be branched by condensing therein small quantities, e.g., 0.05 to 2.0 mol % (relative to the bisphenols) of polyhydroxyl compounds. Polycarbonates of this type have been described, for example, in German Offenlegungsschriften 1,570,533; 2,116,974 and 2,113,374; British Patents 885,442 and 1,079,821 and U.S. Pat. No. 3,544,514, which is incorporated herein by reference. The following are some examples of polyhydroxyl compounds which may be used for this purpose: phloroglucinol; 4,6-dimethyl-2,4,6-tri-(4-hydroxy-phenyl)-heptane; 1,3,5-tri-(4-hydroxyphenyl)-benzene; 1,1,1-tri-(4-hydroxyphenyl)-ethane, tri-(4-hydroxyphenyl)-phenyl-methane; 2,2-bis-[4,4-(4,4′-dihydroxydiphenyl)]-cyclohexyl-propane; 2,4-bis-(4-hydroxy-1-isopropylidine)-phenol; 2,6-bis-(2′-dihydroxy-5′-methylbenzyl)-4-methyl-phenol; 2,4-dihydroxybenzoic acid; 2-(4-hydroxy-phenyl)-2-(2,4-dihydroxy-phenyl)-propane and 1,4-bis-(4,4′-dihydroxytri-phenylmethyl)-benzene. Some of the other polyfunctional compounds are 2,4-dihydroxy-benzoic acid, trimesic acid, cyanuric chloride and 3,3-bis-(4-hydroxyphenyl)-2-oxo-2,3-dihydroindole.

In addition to the polycondensation process mentioned above, other processes for the preparation of the polycarbonates of the invention are polycondensation in a homogeneous phase and transesterification. The suitable processes are disclosed in U.S. Pat. Nos. 3,028,365; 2,999,846; 3,153,008; and 2,991,273 which are incorporated herein by reference.

The preferred process for the preparation of polycarbonates is the interfacial polycondensation process. Other methods of synthesis in forming the polycarbonates of the invention, such as disclosed in U.S. Pat. No. 3,912,688, incorporated herein by reference, may be used. Suitable polycarbonate resins are available in commerce, for instance, from Bayer MaterialScience under the MAKROLON trademark.

Triphenyl phosphine shown in structural formula (3) below is frequently used in the commercial production of polycarbonate parts

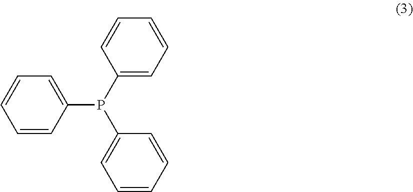 [SMILES: c1ccc(P(c2ccccc2)c2ccccc2)cc1]

Phosphites, such as tris(2,4-di-tert-butylphenyl)phosphite, shown in structural formula (4) below are also used in commercial production of molded parts,

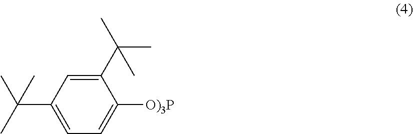

Both of these types of compounds have shown themselves to be less than satisfactory as molders frequently complain of the presence of “water-spots” when producing plastic parts from compositions containing them.

Diphosphites, such as bis(2,4-dicumylphenyl)pentaerythritol diphosphite, shown in structural formula (5) below, proved superior to the state of the art compounds in reducing static charge build-up.

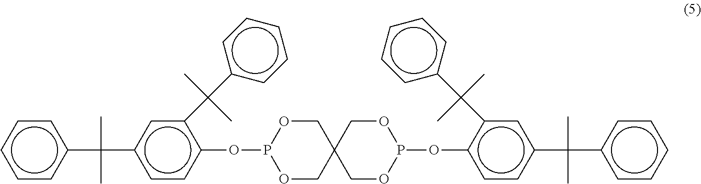

The diphosphite is preferably included in an amount of from 0.04% by weight to 0.4% by weight based on the weight of the composition. The diphosphite may be present in the composition in the present invention in an amount ranging between any combination of these values, inclusive of the recited values.

### EXAMPLES

The present invention is further illustrated, but is not to be limited, by the following examples. All quantities given in “parts” and “percents” are understood to be by weight, unless otherwise indicated.

The following materials were used in generating the samples depicted in the Examples:

| | |
|---|---|
| PC | a homopolycarbonate based on bisphenol A, |
| | having a melt flow rate in accordance with |
| | ASTM D1238 of about 20 g/10 min., |
| | commercially available as MAKROLON |
| | FCR2458 from Bayer MaterialScience; |
| TPP | triphenyl phosphine |
| PHOSPHITE | tris (2,4-di-tert-butylphenyl)phosphite |
| | commercially available as IRGAFOS 168 from |
| | Ciba Specialty Chemicals, Inc.; |
| DIPHOSPHITE | bis (2,4-dicumylphenyl) pentaerythritol |
| | diphosphite, commercially available as |
| | DOVERPHOS S-9228 from Dover Chemical |
| | Corp; |
| ANTIOXIDANT | sterically hindered phenolic antioxidant, |
| | commercially available as IRGANOX 1076 from |
| | Ciba Specialty Chemicals, Inc.; |
| UV ABSORBER | 2-(2H-benzotriazol-2-yl)-4-(1,1,3,3- |
| | tetramethylbutyl)phenol, commercially available |
| | as Tinuvin 329 from BASF. |

The following physical properties were determined: tensile modulus was determined according to ISO 527, Izod impact was determined according to ISO 180/1A, heat deflection temperature was determined according to ISO 75 and Vicat softening temperature was determined according to ISO 306.

| | 11MIIDP1099-A | 11MIIDP1099-B | 11MIIDP1606-A | 11MIIDP1606-B | 11MIIDP1606-C | 11MIIDP1606-D | 11MIIDP1606-E | 11MIIDP1606-F |
|---|---|---|---|---|---|---|---|---|
| PC | 11,307 g | 11,306 g | 11,302 g | 11,300 g | 11,305 g | 11,307 g | 11,266 g | 11,305 g |
| TPP | | | | | | | | |
| PHOSPHITE | 4.536 g | | 4.536 g | 4.536 g | 4.536 g | 2.2679 g | 45.3601 g | |
| DIPHOSPHITE | | 5.6699 g | | | | | | 4.536 g |
| UV | 28.3501 g | 28.3495 g | 28.3501 g | 28.3501 g | 28.3501 g | 28.349 g | 28.3501 g | 28.3501 g |
| ABSORBER | | | | | | | | |
| ANTIOXIDANT | | | 4.536 g | 6.804 g | 2.268 g | 2.2679 g | | 2.268 g |
| Physical | | | | | | | | |
| Properties | | | | | | | | |
| Tensile | 2328 | 2286 | 2300 | 2286 | 2262 | 2190 | 2172 | 2202 |
| modulus | | | | | | | | |
| (MPa) | | | | | | | | |
| Izod | 76.45 | 82.43 | 80.03 | 81.60 | 83.49 | 81.69 | 81.33 | 80.78 |
| impact(kJ/m²) | | | | | | | | |
| Heat deflection | 119.45 | 120.45 | 121.85 | 120.55 | 121.40 | 121.40 | 120.40 | 121.15 |
| temperature (° C.), 1.8 MPa | | | | | | | | |
| Vicat softening | 142.55 | 142.65 | 144.95 | 144.6 | 144.95 | 145.35 | 144.50 | 144.75 |
| temperature | | | | | | | | |
| (° C.) | | | | | | | | |

| | 11MIIDP1606-G | 11MIIDP1606-H | 11MIIDP1606-I | 11MIIDP1606-J | 11MIIDP1606-K | 11MIIDP1606-L | 11MIIDP1606-M | 11MIIDP1606-N | 11MIIDP1606-O |
|---|---|---|---|---|---|---|---|---|---|
| PC | 11,306 g | 11,300 g | 11,305 g | 11,307 g | 11,304 g | 11,306 g | 11,302 g | 11,309 g | 11,311 g |
| TPP | | | | | 2.857 g | 2.8575 g | 2.8564 g | 2.8581 g | |
| PHOSPHITE | | | | | | | | | |
| DI- | 4.536 g | 4.536 g | 2.268 g | 4.536 g | | | | | |
| PHOSPHITE | | | | | | | | | |
| UV | 28.3501 g | 28.3501 g | 28.3501 g | 28.3501 g | 28.343 g | 28.3487 g | 28.3373 g | 28.3543 g | 28.3501 g |
| ABSORBER | | | | | | | | | |
| ANTI- | 0.4536 g | 6.804 g | 4.536 g | | 4.5349 g | 2.2679 g | 6.801 g | | |
| OXIDANT | | | | | | | | | |
| Physical | | | | | | | | | |
| Properties | | | | | | | | | |
| Tensile | 2248 | 2264 | 2164 | 2176 | 2200 | 2242 | 2294 | 2236 | 2275 |
| modulus | | | | | | | | | |
| (MPa) | | | | | | | | | |
| Izod impact | 83.04 | 82.65 | 79.57 | 81.8 | 81.46 | 83.21 | 83.01 | 80.17 | 82.11 |
| (kJ/m²) | | | | | | | | | |
| Heat | 121.05 | 120.10 | 120.55 | 120.45 | 119.95 | 120.45 | 120.30 | 119.6 | 121.65 |
| deflection | | | | | | | | | |
| temperature (° C.), 1.8 MPa | | | | | | | | | |
| Vicat | 145.20 | 144.25 | 144.30 | 144.70 | 144.20 | 144.40 | 144.70 | 144.55 | 145.10 |
| softening | | | | | | | | | |
| temperature | | | | | | | | | |
| (° C.) | | | | | | | | | |

Lab and production sample evaluation to assess level of static charge was performed using talcum powder or carbon black for the visualization of dust patterns. Monroe probe measurements were performed to more provide quantitative measures of relative static charge.

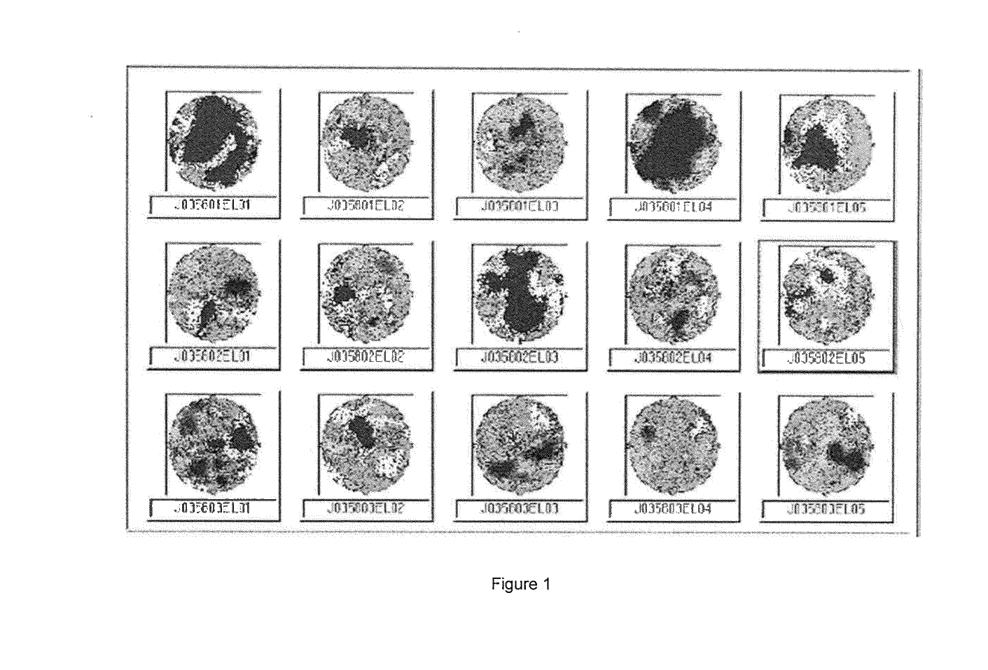

FIG. 1 shows dust pattern results measured with a Monroe probe. The upper horizontal line of patterns depict compositions including triphenyl phosphine. The middle horizontal line of patterns are for compositions including tris(2,4-di-tert-butylphenyl)phosphite and the lower horizontal line of patterns are for compositions including bis(2,4-dicumylphenyl)pentaerythritol diphosphite. As can be appreciated by reference to FIG. 1, the compositions which included bis(2,4-dicumylphenyl)pentaerythritol diphosphite had a significantly reduced static charge build-up.

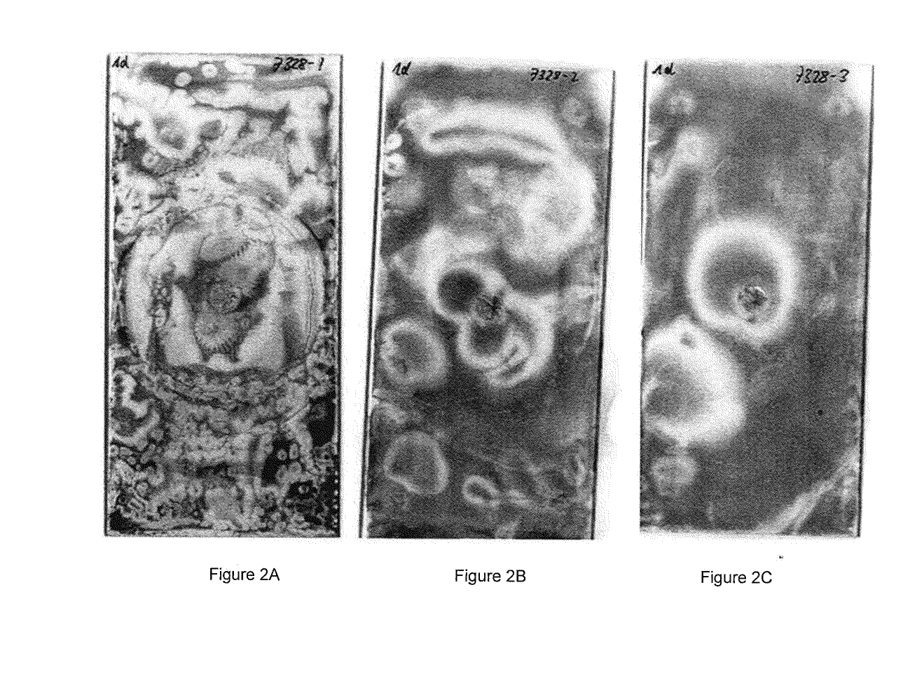

FIGS. 2A, 2B and 2C are photographs of dust patterns measured with a Monroe probe. FIG. 2A shows the dust pattern for a polycarbonate composition including triphenyl phosphine. FIG. 2B shows the dust pattern for a polycarbonate composition including tris(2,4-di-tert-butylphenyl)phosphite and FIG. 2C shows the dust pattern for compositions including bis(2,4-dicumylphenyl)pentaerythritol diphosphite. As can be appreciated by comparison of FIGS. 2A, 2B and 2C, there is substantially less charge build-up shown by the dust pattern for compositions including bis(2,4-dicumylphenyl)pentaerythritol diphosphite.

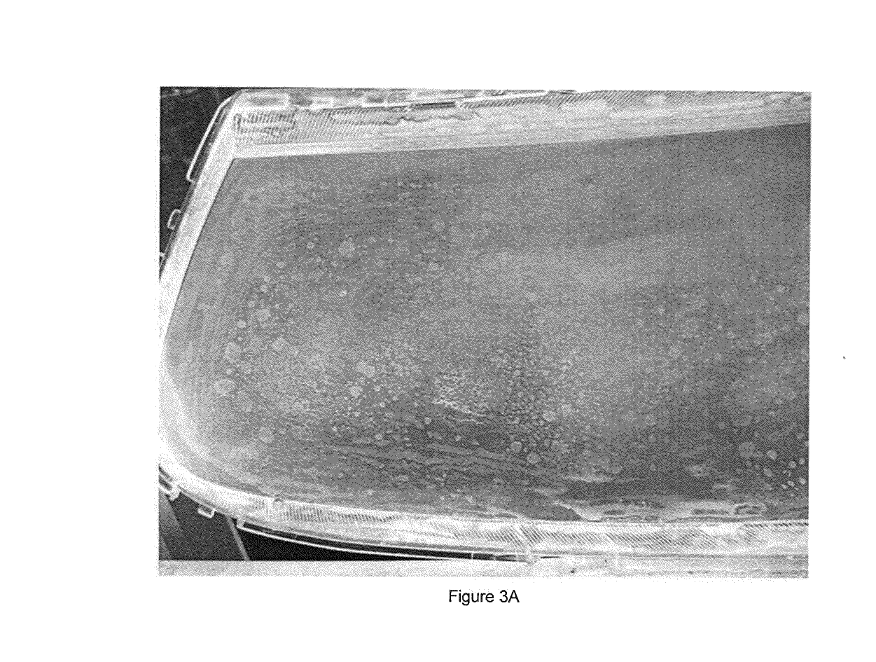

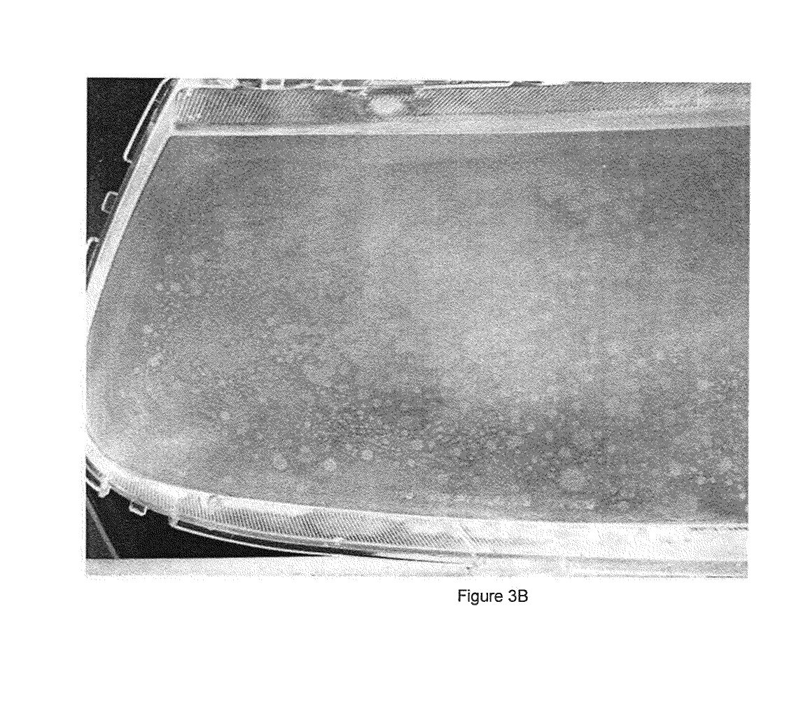

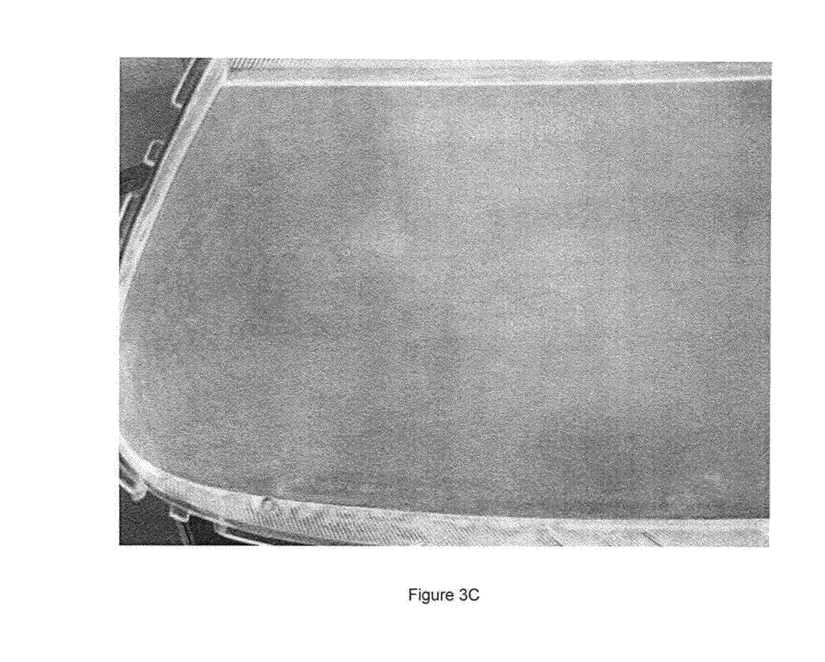

FIGS. 3A, 3B and 3C are photographs of headlight lenses immediately after being removed from the mold. FIG. 3A is a photograph of a polycarbonate headlight lens made with triphenyl phosphine showing a large number of so-called “water-spots.” FIG. 3B is a photograph of a polycarbonate headlight lens made with tris(2,4-di-tert-butylphenyl)phosphite showing a lesser, but still significant, number of “water-spots.” FIG. 3C is a photograph of a polycarbonate headlight lens made with bis(2,4-dicumylphenyl)pentaerythritol diphosphite showing very few “water-spots.”

As can be appreciated by the above, the order of effectiveness in reducing static charge and resultant “water-spots” is
DIPHOSPHITE>>PHOSPHITE>TPP

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A process for reducing static charge in a polycarbonate part comprising: combining a polycarbonate and a diphosphite to form a composition; and
molding a part from the composition,
wherein the part exhibits reduced static charge compared to a part made without addition of the diphosphite.

2. The process according to claim 1, wherein the diphosphite comprises bis(2,4-dicumylphenyl)pentaerythritol diphosphite.

3. The process according to claim 1, wherein the diphosphite is included in an amount of from about 0.04% by weight to about 0.4% by weight based on the weight of the composition.

4. The process according to claim 1, wherein the part comprises an automobile headlight lens.

5. A composition made by a process comprising combining a polycarbonate and a diphosphite to form a composition, wherein a part made from the composition exhibits reduced static charge compared to a part made from a composition without addition of the diphosphite.

6. A part made by the process according to claim 1.
